(19) United States
(12) Patent Application Publication
(10) Pub. No.: US 2024/0354734 A1
(43) Pub. Date: Oct. 24, 2024

(54) CLIENT-SIDE TRANSACTION MODIFICATIONS

(71) Applicant: American Express Travel Related Services Company, Inc., New York, NY (US)

(72) Inventors: Sorin Grigore, Brooklyn, NY (US); Hayley Justina Younghusband, New York, NY (US)

(21) Appl. No.: 18/303,306

(22) Filed: Apr. 19, 2023

(51) Int. Cl. G06Q 20/32; G06Q 20/20; G06Q 20/38; G06Q 20/40; G06Q 20/42

(52) U.S. Cl. CPC G06Q 20/3267; G06Q 20/20; G06Q 20/389; G06Q 20/401; G06Q 20/42

(57) ABSTRACT

Disclosed are various embodiments for modifying transactions. A computer device can determine that a transaction has been authorized for an account, the transaction including an authorization amount and a merchant identifier. Then, the computing determine that the merchant identifier is included in a set of merchant identifiers associated with a transaction modification program. Next, the computing device can determine that the account is included in a set of accounts enrolled with the transaction modification program. Subsequently, in response to the first determination that the merchant identifier is included in the set of merchant identifiers associated with the transaction modification program and the second determination that the account is included in a set of accounts enrolled with the transaction modification program, the computing device can send a notification to an application executing on a client device associated with the account, the notification indicating that the transaction is a modifiable transaction.

### BACKGROUND

Users often purchase goods or services using credit, debit, or charge cards. As part of the purchase process, users are often prompted to provide a tip or gratuity. Many users may choose not to provide a tip or gratuity for a variety of reasons, such as feeling uncomfortable with providing a gratuity prior to receiving the purchased goods or services or because the transaction is one where tips or gratuities are not normally solicited or provided. However, some of these users may change their minds and wish to modify the transaction at a later point in time to include a gratuity.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1-9 are drawings depicting various embodiments of the present disclosure.

FIG. 10 is a drawing of a network environment according to various embodiments of the present disclosure.

FIGS. 11-13 are sequence diagrams illustrating interactions between various components of the network environment of FIG. 10 according to various embodiments of the present disclosure.

### DETAILED DESCRIPTION

Disclosed are various approaches for allowing a user to modify a transaction after it has been authorized. When a user initiates a transaction, the user may be prompted at the point-of-sale to modify the amount of the transaction. For example, a user making a five-dollar purchase may be prompted to add a tip, increasing the overall cost of the transaction. However, the user may not wish to modify the transaction at that time, but still retain the option to modify the transaction later. For example, a user may feel uncomfortable adding a tip to a transaction prior to completion of the service or receiving the goods purchased or a user may wish to make his or her decision to tip in private instead of in view of the service provider or other customers.

Previously, users have not had the technical ability to modify a transaction after it is completed. Once the user authorizes the transaction, such as a credit, debit, or charge card purchase, a transaction authorization request is submitted to the financial institution that issued the credit, debit, or charge card. If the transaction authorization request is approved, the transaction is finalized and funds are transferred from the account of the user to the account of the merchant. The user is unable to modify the transaction because it has been completed. Accordingly, if the user changed his or her mind after the transaction had been completed about whether or not leave a tip, the user would be unable to do so.

Various embodiments of the present disclosure provide a technical solution to this problem. For example, embodiments of the present disclosure allow a user to add or include a tip or gratuity in a transaction without having to use the point-of-sale device of the merchant. By separating the experience of including a tip or gratuity, or otherwise modifying the transaction, from the point-of-sale device, users can modify transactions at any subsequent point in time.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

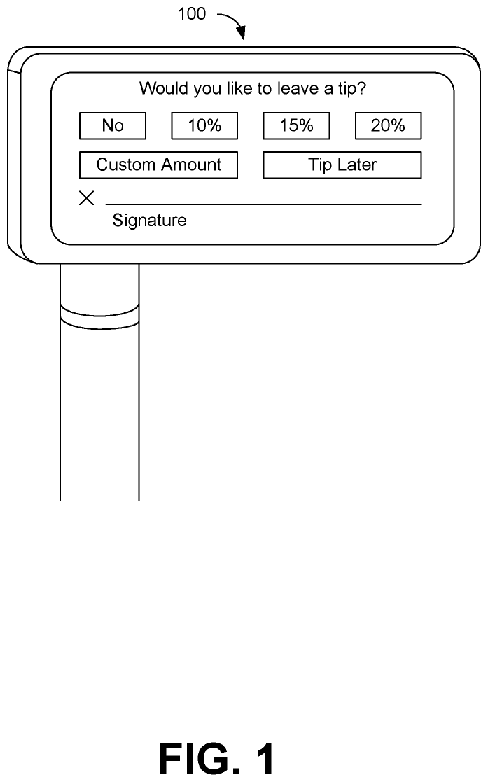

FIGS. 1-4 depict various examples of scenarios where a user could begin a transaction modification process according to various embodiments of the present disclosure. In each of these examples, a user is notified of a transaction and has the opportunity to adjust or modify the transaction at a later point in time. For example, a user could change a transaction after the fact to add a tip to the transaction amount.

For example, in FIG. 1, a user could be interacting with a point-of-sale (PoS) device 100 as part of the checkout process for purchasing an item or service (e.g., a cup of coffee at the coffee shop, food at a restaurant, items at a hardware store, etc.). The PoS device 100, as part of the checkout process, could prompt the user to submit a tip. For example, the user could be given the option not to tip, tip based on a percentage of the transaction amount, provide a custom tip amount, or to tip later (e.g., by using various embodiments of the present disclosure). The “tip later” option could also be referred to in other manners, such as “Tip in App.”

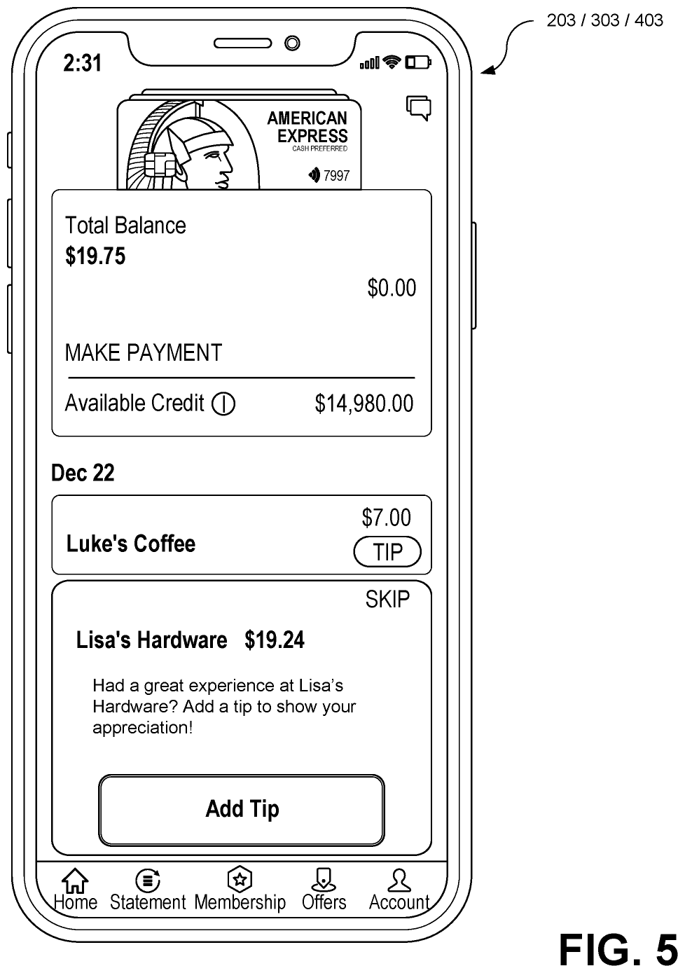

If the user selected the tip later option in FIG. 1, then the user could then receive a notification 200 on his or her client device 203. The notification 200 could remind the user that he or she had chosen to tip later. If the user selects or interacts with the notification 200, then the user could proceed to the user interface depicted in FIG. 5.

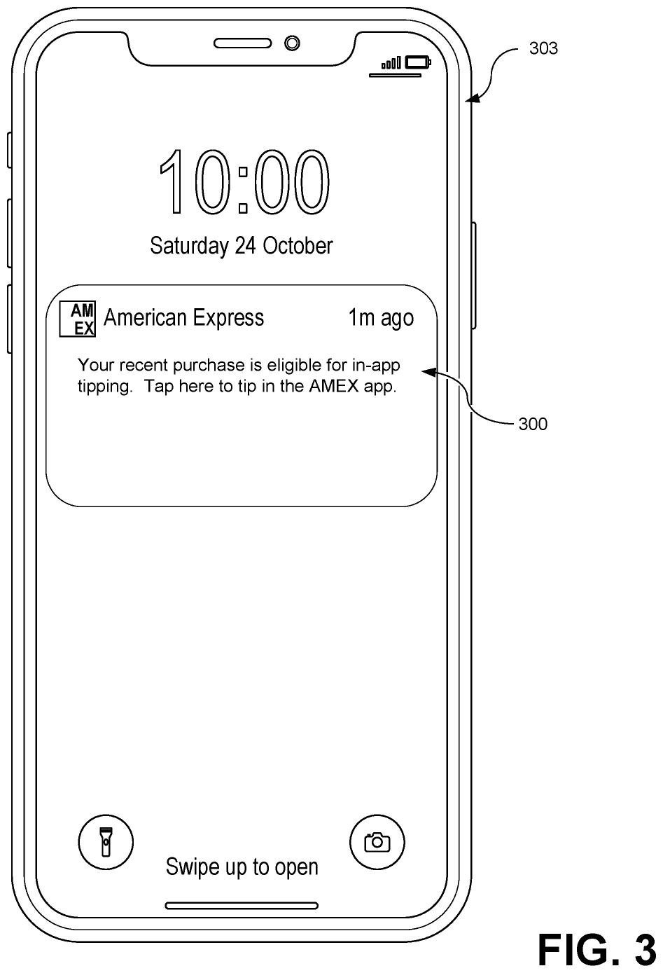

In another example, such as the example depicted in FIG. 3, a user could receive a notification after a transaction has been completed that the transaction is eligible for modification. For example, some merchants might use POS systems that do not prompt for tips or cannot be configured to prompt for tips. However, these merchants could still enroll in, register with, or otherwise consent to transaction modifications. If a user completes a transaction with such a merchant, the user could receive a notification 300 on his or her client device 303 informing the user that the transaction can be modified (e.g., by adding a tip). If the user selects or interacts with the notification 300, then the user could proceed to the user interface depicted in FIG. 5.

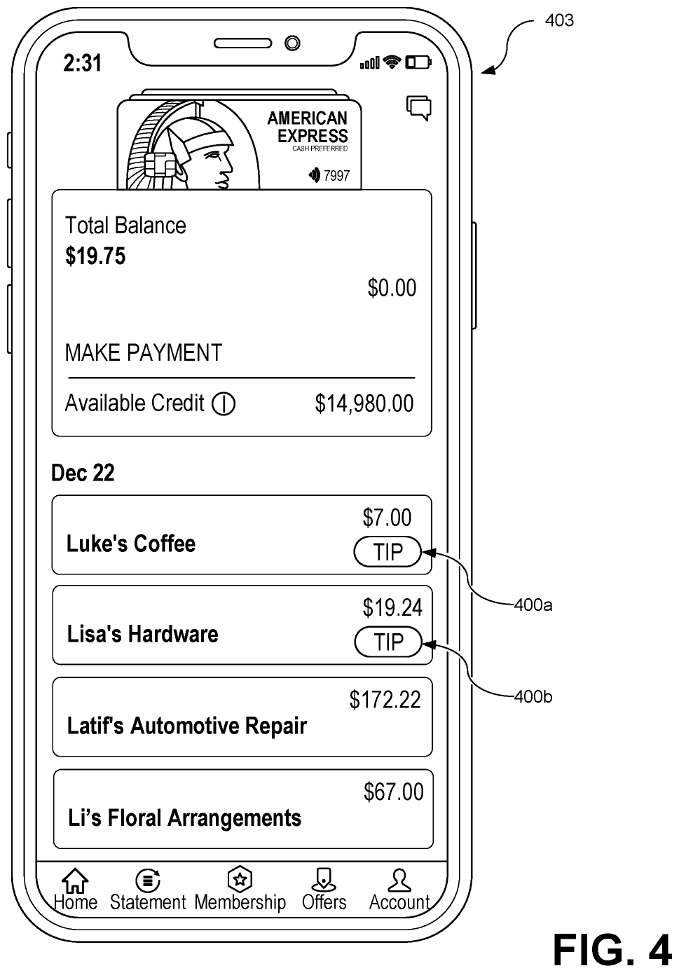

FIG. 4 depicts another example of how a user could begin the process of modifying a transaction according to various embodiments of the present disclosure. Unlike the embodiments depicted in FIGS. 1-3, in FIG. 4 a user could be presented with a list of transactions within the user interface. Those transactions which are eligible for modification could have a user interface element 400 (e.g., user interface element 400a and user interface element 400b) placed in the vicinity of the transaction description. The presence of a user interface element 400 can serve to identify which transactions can be modified at a later point in time (e.g., by adding a tip). The presence of the user interface element 400 can also serve to allow a user to select and begin the process of modifying a previous transaction (e.g., by adding a tip). For example, if the user were to interact with the user interface element 400b for the transaction at “Lisa's Hardware,” then the user could be presented with the user interface depicted in FIG. 5.

FIG. 5 depicts a client device, such as the client device 203, 303, or 403, presenting a user with the option to modify a transaction (e.g., add a tip). As previously discussed in the descriptions of FIGS. 1-4, a user could arrive at the user interface of FIG. 5 through a variety of different workflows. However, here a transaction may be displayed within the user interface of FIG. 5, with an option to modify the transaction (e.g., “Add Tip”). The user could modify the transaction (e.g., add a tip), or skip or otherwise decline the modification.

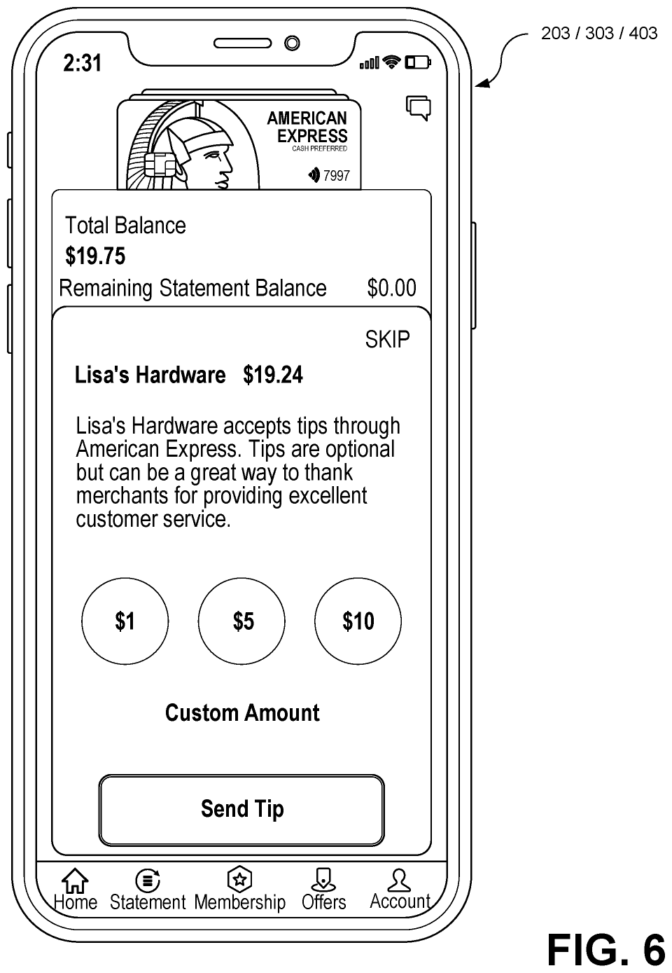

If the user chooses to modify the transaction (e.g., add a tip), then the user could be presented next with the user interface depicted in FIG. 6. As shown in FIG. 6, a user can be prompted for an amount to modify the transaction, such as an amount of a tip to add to the transaction. In some implementations, multiple options could be suggested, such as a flat rate amount or an amount equal to a percentage of the transaction. These suggestions could be provided by the POS device 100 of the merchant or the suggestions could be default suggestions used with any transaction. For example, a restaurant could provide suggested tip amounts equal to 15%, 18%, or 20% of the transaction, while a coffee shop might suggest tips amounts equal to one dollar, three dollars, or five dollars, etc. Moreover, a default amount could be preselected in some implementations. In these implementations, the default amount could be a default selected by the issuer or payment processor. In other implementations, the default amount could be a user specified preference For example, the transaction authorization service 1013 could cause the smallest tip amount to be selected by default for all users, or for an 18% tip to be selected by default for a transaction with a restaurant for all users. These default amounts could be confirmed or modified by the user. However, a user could also specify his or her own default, such as a 20% default tip for restaurants. In these instances, the transaction authorization service 1013 could cause a default tip of 20% to be presented to the user for all restaurant transactions. In addition, in some implementations, the user could also be presented with the option to enter a custom or user-specified amount. Once the user provides the amount to modify the transaction by (e.g., an amount for a tip), or confirms the suggested or default amount, the user could submit the amount using the user interface to his or her financial institution.

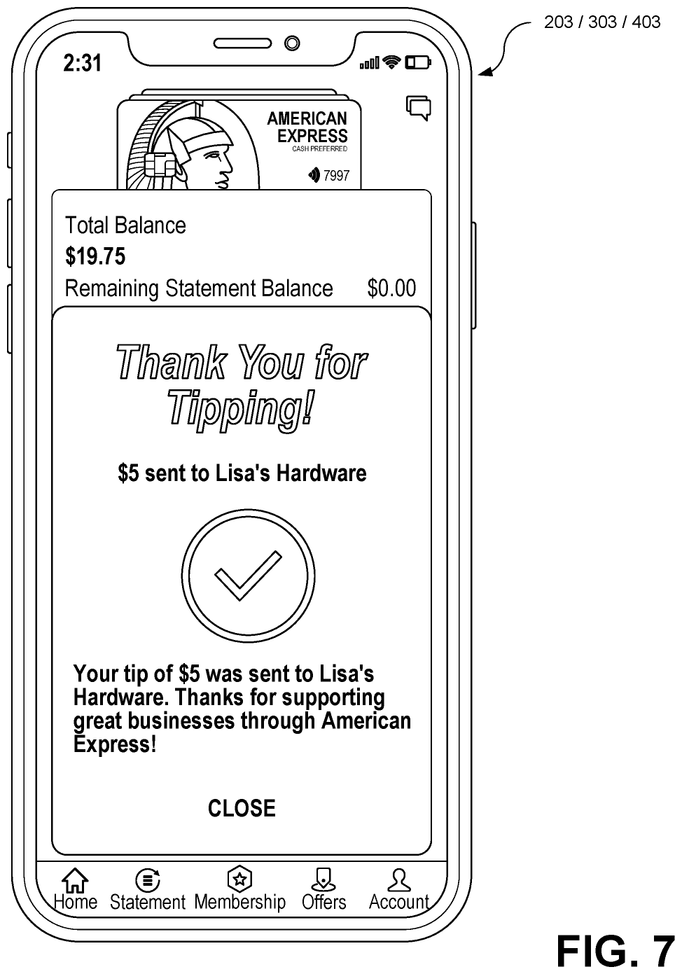

Subsequently, the user could be presented with user interface that includes a confirmation that transaction had been modified by the amount specified. For example, the user interface could confirm that the selected or provided tip amount had been submitted successfully to his or her financial institution. An example of a user interface that includes such a confirmation is depicted in FIG. 7.

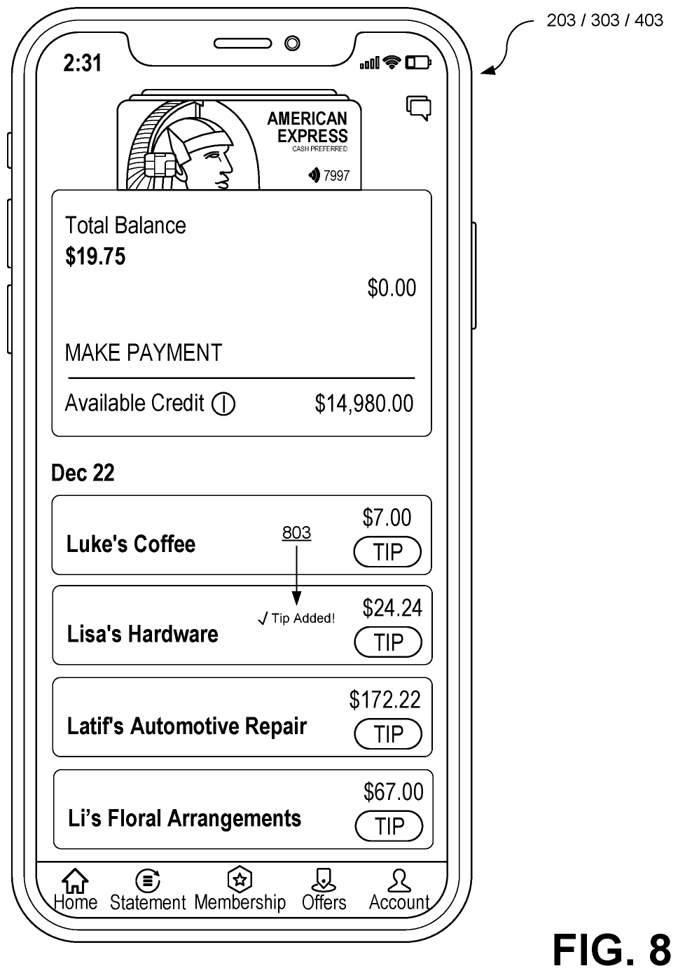

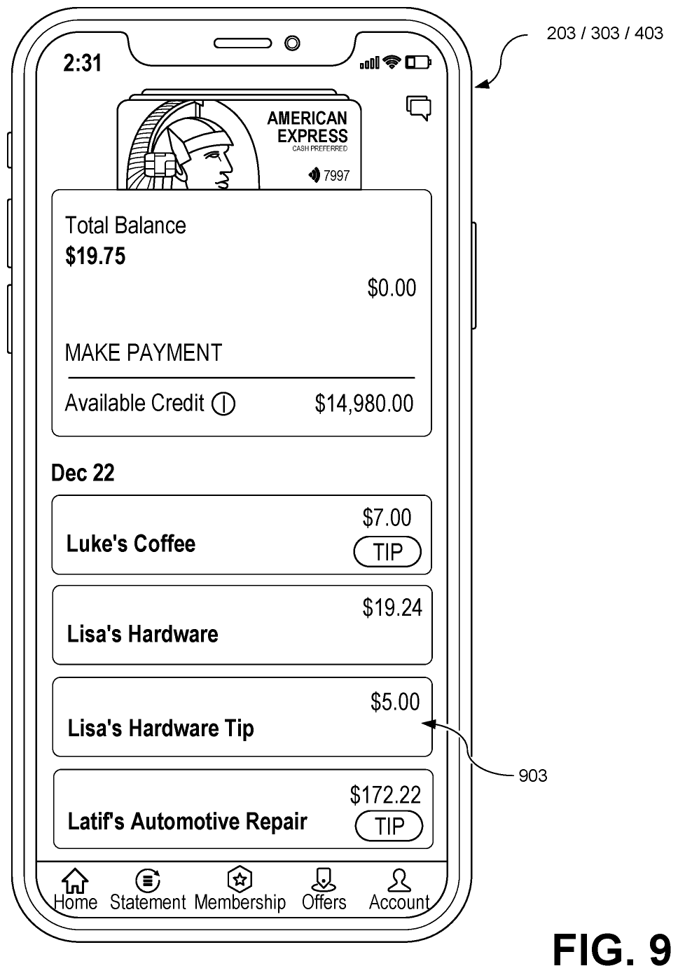

Users may, at some points in time, wish to see which transactions have been modified. For example, a user may wish to see which transactions a user has subsequently added a tip to. This information could be presented to the user in a number of ways. For example, FIG. 8 depicts a list of transactions, where at least one transaction is flagged by an indicator 803 to show that the transaction has been modified (e.g., that a tip has been added). As another example, FIG. 9 depicts a list of transactions, which includes an additional transaction 903 that represents the amount of the modification (e.g., the amount of a tip). Other approaches could be used according to various embodiments of the present disclosure.

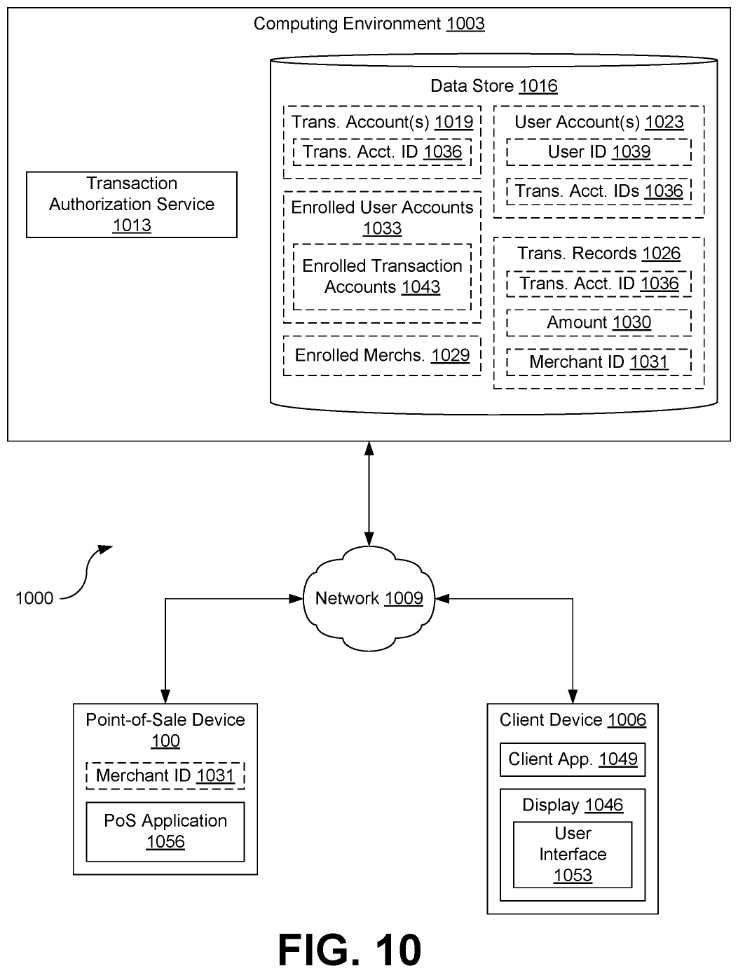

With reference to FIG. 10, shown is a network environment 1000 according to various embodiments. The network environment 1000 can include a computing environment 1003, a point-of-salepoint-of-sale device 100, a client device 1006, which can be in data communication with each other via a network 1009.

The network 1009 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 1009 can also include a combination of two or more networks 1009. Examples of networks 1009 can include the Internet, intranets, extranets, virtual private networks (VPNs), and similar networks.

The computing environment 1003 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 1003 can employ a plurality of computing devices that can be arranged in one or more server banks or computer banks or other arrangements. Such computing devices can be located in a single installation or can be distributed among many different geographical locations. For example, the computing environment 1003 can include a plurality of computing devices that together can include a hosted computing resource, a grid computing resource or any other distributed computing arrangement. In some cases, the computing environment 1003 can correspond to an elastic computing resource where the allotted capacity of processing, network, storage, or other computing-related resources can vary over time.

Various applications or other functionality can be executed in the computing environment 1003. The components executed on the computing environment 1003 include a transaction authorization service 1013 and other applications, services, processes, systems, engines, or functionality not discussed in detail herein.

Also, various data is stored in a data store 1016 that is accessible to the computing environment 1003. The data store 1016 can be representative of a plurality of data stores 1016, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 1016 is associated with the operation of the various applications or functional entities described below. This data can include one or more transaction accounts 1019, one or more user accounts 1023, one or more transaction records 1026, one or more enrolled merchants 1029, one or more enrolled user accounts 1033, and potentially other data.

Individual transaction accounts 1019 can represent various payment accounts that can be used to make a payment from one party to another, such as from a customer or consumer to a merchant. Examples of transaction accounts can include credit card accounts, charge card accounts, debit card accounts, checking accounts, money market accounts, or other demand deposit, stored value, or credit accounts. Accordingly, each transaction account 1019 can include a transaction account identifier 1036 that uniquely identifies the transaction account 1019 with respect to other transaction accounts 1019. Examples of transaction account identifiers 1036 include personal account numbers such as credit card numbers, debit card numbers, charge card numbers, demand deposit account (DDA) numbers (e.g., for checking, savings, and similar accounts), as well as tokenized versions of the same.

Individual user accounts 1023 can represent information related to individual users or customers of a transaction account issuer. For example, a customer of a bank might have one user account representing the user and his or her relationship with the bank. Accordingly, a user account 1023 can include a user identifier 1039 that uniquely identifies a user account 1023 with respect to another user account 1023. A user account 1023 can also include one or more transaction account identifiers 1036, which serve to identify the transaction accounts 1019 the user is authorized to use, either as the owner of the transaction account 1019 or as an authorized user of the transaction account 1019.

Individual transaction records 1026 can represent information associated with a transaction using a transaction account 1019. Transaction records 1026 can be created in response to authorization of the transaction by the transaction authorization service 1013. Transaction records 1026 can store relevant data such as the transaction account identifier 1036 of the transaction account 1019 used to fund or pay for the transaction, the amount 1030 of the transaction, and the merchant identifier 1031 of the merchant who submitted the transaction for authorization as the merchant of record.

The enrolled merchants 1029 can represent those merchants that have consented to have authorized transactions modified by customers at a later point in time. Accordingly, the enrolled merchants 1029 can include a list of merchant identifiers 1031 of each merchant that is participating, enrolled in, or has otherwise consented to having authorized transaction modified.

The enrolled user accounts 1033 can represent those user accounts 1023 of users have requested to be allowed modify transactions with merchants at a later point in time. Accordingly, the enrolled user accounts 1033 can include the user identifiers 1039 of the user accounts 1023 of users who have consented to or registered or enrolled with the transaction modification program or service implemented by the transaction authorization service 1013. In some implementations, individual users may have multiple transaction accounts 1019 associated with their user account 1023, such as when a user has separate transaction accounts 1019 for work and personal expenses or multiple transaction accounts 1019 to maximize rewards programs or other benefits. In these implementations, a user might enroll one or more transaction accounts 1019, but not all of the transaction accounts 1019 that the user is eligible to register. In these situations, each of the enrolled user accounts 1033 may also include a list of enrolled transaction accounts 1043 that includes the transaction account identifier 1036 of each transaction account 1019 that the user has selected to enable or participate in a transaction modification program.

The transaction authorization service 1013 can be executed to receive an authorization request for a transaction from a point-of-sale device 100 and authorize the transaction if various criteria are met. For example, the transaction authorization service 1013 could receive an authorization request from a point-of-sale device 100 for a transaction involving a credit card. The transaction authorization service 1013 could evaluate the transaction based on factors such as the likelihood that the transaction is fraudulent or legitimate, whether the transaction account has sufficient funds or credit available to pay for or fund the transaction, etc. If the criteria are satisfied, the transaction authorization service 1013 can authorized the transaction, thereby causing funds to be transferred from the transaction account 1019 of the user to the account of the merchant associated with the point-of-sale device 100. The transaction authorization service 1013 can also create a transaction record 1026 recording the transaction and save the transaction record 1026 to the data store 1016.

The transaction authorization service 1013 can also be executed to modify an authorized transaction at a later point in time. For example, if a user wishes to add a tip to a previously authorized transaction, the transaction authorization service 1013 could be executed to create a new transaction that includes at least the tip amount and submit the new transaction to the transaction authorization service 1013 for authorization.

The client device 1006 is representative of a plurality of client devices (e.g., client devices 203, 303, or 403) that can be coupled to the network 1009. The client device 1006 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 1006 can include one or more displays 1046, such as liquid crystal displays (LCDs), gas plasma-based flat panel displays, organic light emitting diode (OLED) displays, electrophoretic ink (“E-ink”) displays, projectors, or other types of display devices. In some instances, the display 1046 can be a component of the client device 1006 or can be connected to the client device 1006 through a wired or wireless connection.

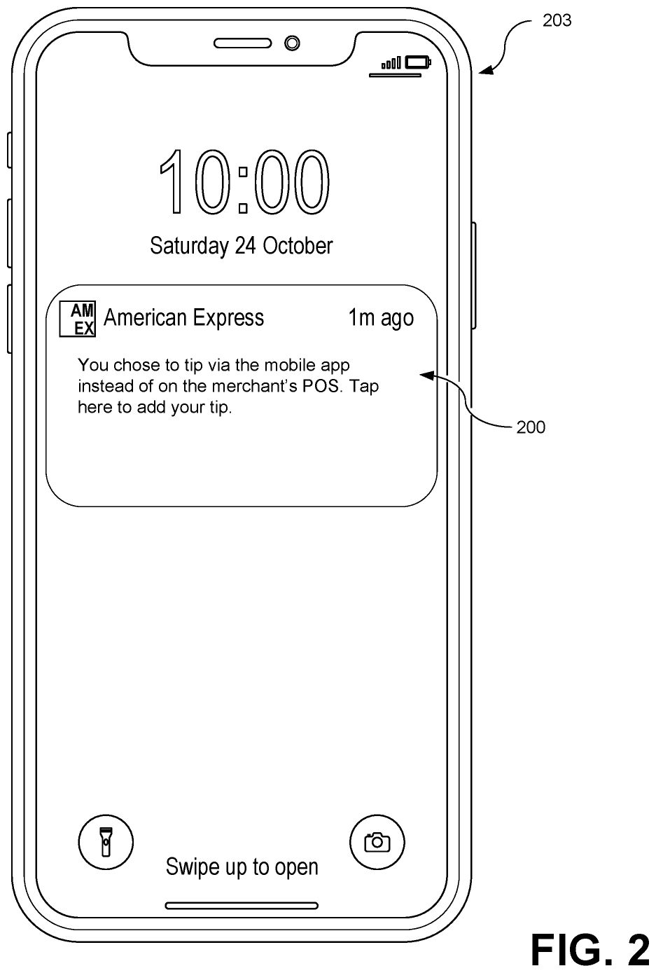

The client device 1006 can be configured to execute various applications such as a client application 1049 or other applications. The client application 1049 can be executed in a client device 1006 to access network content served up by the computing environment 1003 or other servers, thereby rendering a user interface 1053, such as the user interfaces depicted in FIGS. 2-9, on the display 1046. To this end, the client application 1049 can include a browser, a dedicated application, or other executable, and the user interface 1053 can include a network page, an application screen, or other user mechanism for obtaining user input. The client device 1006 can be configured to execute applications beyond the client application 1049, such as email applications, social networking applications, word processors, spreadsheets, or other applications.

The point-of-sale (POS) device 100 can represent any device that can be used to initiate, authorize, or complete a transaction between a user and a merchant. Examples of PoS devices 100 can include cash registers, payment terminals (e.g., transaction card terminals, PIN pads, etc.), virtual payment terminals (e.g., a general purpose computer or mobile device with point-of-sale software installed), etc. Accordingly, a PoS device 100 can be configured to execute a PoS application 1056. The PoS application 1056 can be any application that, when executed, initiates a transaction and request authorization of the transaction with the transaction authorization service 1013. As discussed later, the POS application 1056 could be implemented in software or in hardware (e.g., using application specific integrated circuits (ASICs) or other hardware implementations). Accordingly, the POS device 100 can also store information relevant to the transaction authorization process, such as a merchant identifier 1031 of the merchant that owns or operates the POS device 100 and potentially other information.

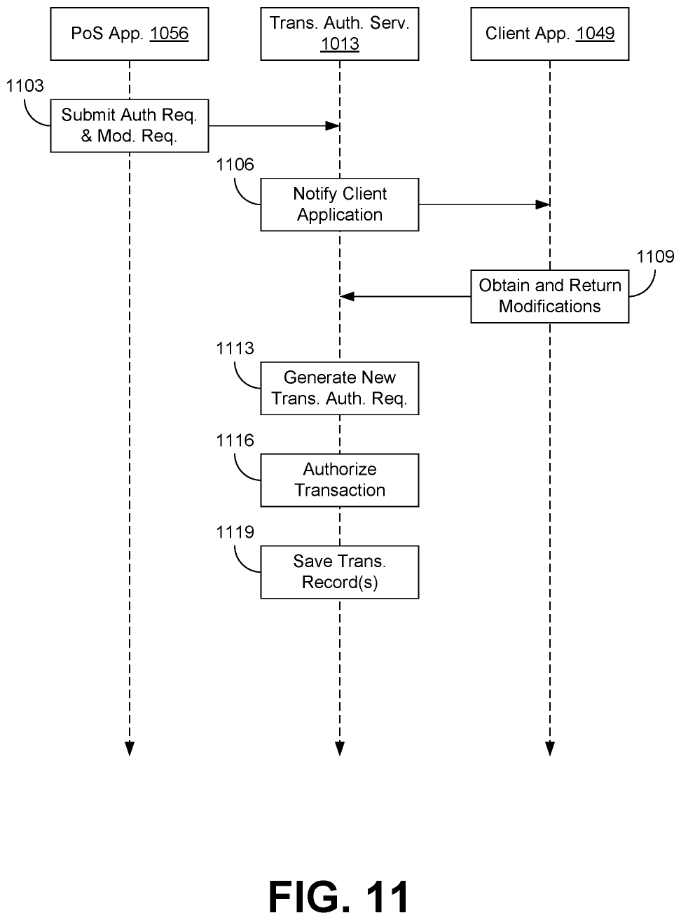

Referring next to FIG. 11, shown is a sequence diagram that provides one example of the interactions between the POS application 1056, the transaction authorization service 1013, and the client application 1049. The sequence diagram of FIG. 11 provides merely an example of the many different types of potential interactions between the POS application 1056, the transaction authorization service 1013, and the client application 1049. As an alternative, the flowchart of FIG. 11 can be viewed as depicting an example of elements of a method implemented within the network environment 1000.

Beginning with block 1103, the POS application 1056 can submit a transaction authorization request and a transaction modification request to the transaction authorization service 1013. The transaction authorization request could be any request to authorize a transaction made by a user with the merchant operating the POS Device 100 executing the POS application 1056. Examples of transaction authorization requests include debit, credit, or charge card authorization requests, which could include a transaction account identifier 1036 (or tokenized version thereof), an amount 1030 to be authorized, a merchant identifier 1031, and potentially other information. However, a transaction authorization request could also be made for transactions using other payment rails or payment networks. The POS application 1056 could also submit a modification request with the transaction authorization request. The modification request could represent a user's intent to modify the transaction at a later point in time (e.g., using the client application 1049) and could include information such as a merchant identifier 1031, an identifier of the transaction, a transaction account identifier 1036 (or tokenized version thereof) for the transaction account 1019 of the user.

The modification request could result from interactions between the user and the POS device 100 or PoS application 1056. For example, a user could have been prompted by the POS application 1056 on the PoS terminal 100 to add a tip later using his or her client application 1049. An example of how a modification request could be obtained from a user by the POS application 1056 or the POS Device 100 is previously illustrated in FIG. 1.

Then, at block 1106, the transaction authorization service 1013 can send a notification to the client application 1049 of the client device 1006 of the user who initiated the transaction with the merchant operating the PoS application 1056. The user could be identified, for example, by cross-referencing the transaction account identifier 1036 (or tokenized version thereof) with transaction account identifiers 1036 linked to user accounts 1023. Once the user account 1023 associated with a particular transaction account 1019 identified by the transaction account identifier 1036, the transaction authorization service 1013 could generate and send a notification to the client application 1049 executing on the client device 1006 of the user. The notification could include information about the transaction with the merchant (e.g., the amount 1030 of the transaction, the identity of the merchant, the date and time of the transaction, etc.), and a prompt or reminder to the user that he or she had indicated to the merchant that he or she would modify the transaction at a later point in time. An example of such a notification presented on the client device 1006 is previously depicted in FIG. 2.

In some implementations, repeated notifications could be sent to the client application 1049. This could occur if the transaction authorization service 1013 determines that a transaction modification has not been received from the client application 1049 within a predefined period of time after the notification was sent to the client application 1049. In these implementations, the transaction authorization service 1013 could send additional notifications to the client application 1049 to remind the user that the transaction is a modifiable transaction.

Next, at block 1109, the client application 1049 can obtain modification data from a user of the client device 1006. This can be done by presenting user interface 1053 on a display 1046 of the client device 1006, which the user can use to input or otherwise provide information such as the amount to modify the transaction by (e.g., how much of a tip to add to the transaction). Examples of a user interface 1053 through which a user could provide transaction modification information is previously illustrated in FIGS. 5-7. A response can then be returned by the client application 1049 to the transaction authorization service 1013, which can include the amount of the modification and, in some implementations, an identifier of the transaction in order to allow the transaction authorization service 1013 to track which transaction is to be modified by the specified amount.

Moving on to block 1113, the transaction authorization service 1013 can generate a new authorization request to reflect the transaction modification received from the client application 1049. For example, the transaction authorization service 1013 could generate a second authorization request that represents the additional amount received from the client application 1049. In other examples, the transaction authorization service 1013 could generate a new authorization request that includes the original amount for the transaction and the additional amount returned by the client application 1049. In these examples, once the new authorization request is generated, the original authorization request could be discarded or reversed because the new authorization request would include the original amount to be authorized for the transaction. Moreover, in both examples, information from the transaction authorization request that was submitted at block 1103 could be used to create the new transaction authorization request, such as the merchant identifier 1031 of the merchant associated with the transaction or the transaction account identifier 1036 of the transaction account used for the transaction.

Proceeding to block 1116, the transaction authorization service 1013 can authorize the transaction. The transaction authorization service 1013 could also concurrently send a confirmation to the client application 1049 that the transaction represented by the transaction authorization request has been authorized. If a second authorization request were generated at block 1113, then the transaction authorization service 1013 could authorize the first transaction authorization request received from the POS application 1056 at block 1103 and the second authorization request generated at block 1113. However, if a second authorization request were created at block 1113 to replace the transaction authorization request received at block 1103, and the first transaction request had been discarded, then only the second authorization requisition would be authorized.

Subsequently, at block 1119, the transaction authorization service 1013 can save one or more transaction records 1026. For example, if the transaction authorization service 1013 authorized two transactions, such as the first transaction authorization request submitted at block 1103 and the second one generated at block 1113, then the authorization service 1011 could create and save two transaction authorization records 1026. As another example, if the transaction authorization service 1013 generated a new transaction authorization request at block 1113 to replace the prior transaction authorization request submitted at block 1103, then the transaction authorization service 1013 could create and save a single transaction record 1026 representing the second transaction authorization request. In both of these examples, the transaction records 1026 could also be flagged, when stored, to indicate that they represent a modified version of an original transaction. This could be done to allow the client application 1049 to indicate to a user which transactions have already been modified (e.g., which transactions have already had a tip added) compared to which transactions are unmodified.

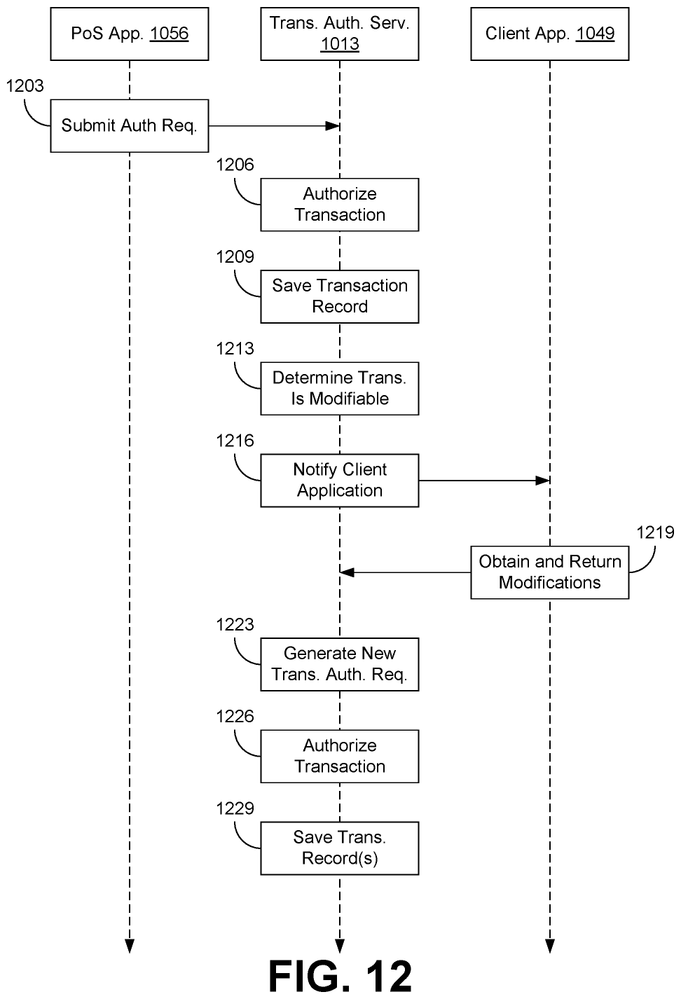

Referring next to FIG. 12, shown is a sequence diagram that provides one example of the interactions between the POS application 1056, the transaction authorization service 1013, and the client application 1049. The sequence diagram of FIG. 12 provides merely an example of the many different types of functional arrangements that can be employed to implement the operation of the depicted portions of the PoS application 1056, the transaction authorization service 1013, and the client application 1049. As an alternative, the sequence diagram of FIG. 12 can be viewed as depicting an example of elements of a method implemented within the network environment 1000.

Beginning with block 1203, the POS application 1056 can submit a transaction authorization request to the transaction authorization service 1013. The transaction authorization request could be any request to authorize a transaction made by a user with the merchant operating the PoS Device 100 executing the PoS application 1056. Examples of transaction authorization requests include debit, credit, or charge card authorization requests. However, a transaction authorization request could also be made for transactions using other payment rails or payment networks.

Then, at block 1206, the transaction authorization service 1013 can authorize the transaction. Once the transaction has been authorized, the transaction authorization service 1013 can save a transaction record 1026 representing the transaction that was authorized. This can include the amount 1030 of the transaction, the merchant identifier 1031 of the merchant associated with the transaction, and the transaction account identifier 1036 of a transaction account 1019 of a user associated with the transaction.

At block 1213 the transaction authorization service 1013 can determine whether or not the transaction authorized at block 1206 is permitted to be modified after the transaction has been authorized. Although depicted as occurring subsequent blocks 1206 and 1209, this could be performed in parallel to block 1206 and 1209. To determine whether the transaction is permitted to be modified after the transaction has been authorized (e.g., if a tip is permitted to be added after the transaction has been completed), the transaction authorization service 1013 could determine whether the merchant identifier 1031 is included in the group or set of enrolled merchants 1029 (e.g., by retrieving the merchant identifier 1031 from the transaction record 1026 of the transaction as saved at block 1209). However, even if the merchant permits transactions to be modified, some users may be uninterested in this functionality or may only have it enabled from some of the transaction accounts 1019. Therefore, in some implementations, the transaction authorization service 1013 could further determine whether the transaction account identifier 103 is one of the enrolled transaction accounts 1043 within the set of enrolled user accounts 1033.

If the transaction is a modifiable transaction, then the transaction authorization service 1013 can continue to block 1216, where the transaction authorization service 1013 can send a message or other notification to the client application 1049 of the client device 1006 of the user who participated in the transaction with the merchant. The user could be identified, for example, by cross-referencing the transaction account identifier 1036 (or tokenized version thereof) with transaction account identifiers 1036 linked to user accounts 1023. Once the user account 1023 associated with a particular transaction account 1019 identified by the transaction account identifier 1036, the transaction authorization service 1013 could generate and send a notification to the client application 1049 executing on the client device 1006 of the user. The notification could include information about the transaction with the merchant (e.g., the amount 1030 of the transaction, the identity of the merchant, the date and time of the transaction, etc.), and a prompt or reminder to the user that he or she had indicated to the merchant that he or she would modify the transaction at a later point in time. An example of such a notification presented on the client device 1006 is previously depicted in FIG. 3.

In some implementations, repeated notifications could be sent to the client application 1049. This could occur if the transaction authorization service 1013 determines that a transaction modification has not been received from the client application 1049 within a predefined period of time after the notification was sent to the client application 1049. In these implementations, the transaction authorization service 1013 could send additional notifications to the client application 1049 to remind the user that the transaction is a modifiable transaction.

Subsequently, at block 1219, the client application 1049 can obtain modification data from a user of the client device 1006. This can be done by presenting user interface 1053 on a display 1046 of the client device 1006, which the user can use to input or otherwise provide information such as the amount to modify the transaction by (e.g., how much of a tip to add to the transaction). Examples of a user interface 1053 through which a user could provide transaction modification information is previously illustrated in FIGS. 5-7. A response can then be returned by the client application 1049 to the transaction authorization service 1013, which can include the amount of the modification and, in some implementations, an identifier of the transaction in order to allow the transaction authorization service 1013 to track which transaction is to be modified by the specified amount.

Moving on to block 1223, the transaction authorization service 1013 can generate a new authorization request to reflect the transaction modification specified by the client application 1049. For example, the transaction authorization service 1013 could generate a second authorization request that represents the additional amount received from the client application 1049. Information from the transaction authorization request that was submitted at block 1203 could be used to create the new transaction authorization request, such as the merchant identifier 1031 of the merchant or the transaction account identifier 1036 associated with the transaction account used for the transaction. In other examples, the transaction authorization service 1013 could generate a new authorization request that includes the original amount for the transaction and the additional amount returned by the client application 1049. In these examples, once the new authorization request is generated, the previously authorized transaction reversed because the new authorization request would include the original amount to be authorized for the transaction as well as the additional amount.

Proceeding to block 1226, the transaction authorization service 1013 can authorize the transaction authorization request generated at block 1223. The transaction authorization service 1013 could also concurrently send a confirmation to the client application 1049 that the transaction represented by the transaction authorization request has been authorized.

Subsequently, at block 1229, the transaction authorization service 1013 can save a transaction record 1026 representing the transaction authorization request generated at block 1223 and authorized at block 1226. The transaction record 1026 could also be flagged, when stored, to indicate that it represents a modified version of an original transaction. This could be done to allow the client application 1049 to indicate to a user which transactions have already been modified (e.g., which transactions have already had a tip added) compared to which transactions are unmodified.

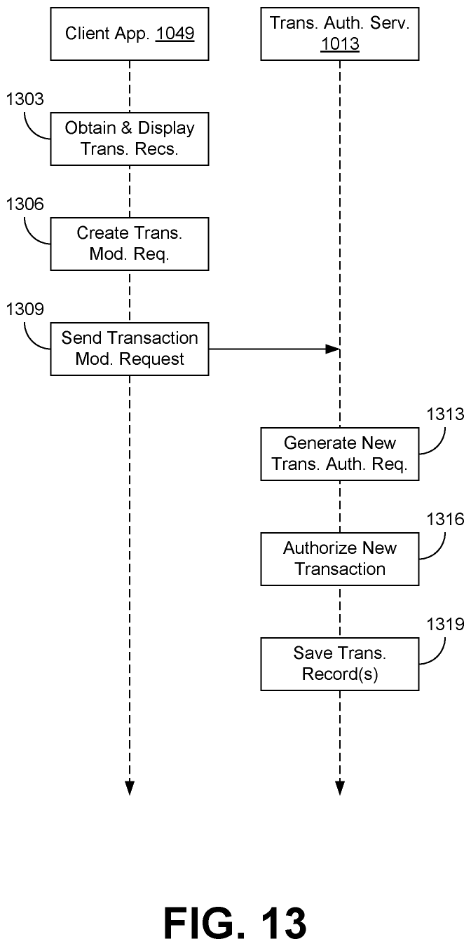

Referring next to FIG. 13, shown is a sequence diagram that illustrates the interactions between the transaction authorization service 1013 and the client application 1049. The sequence diagram of FIG. 13 provides merely an example of the many different types of functional arrangements that can be employed to implement the operation of the depicted portions of the transaction authorization service 1013 or the client application 1049. As an alternative, the flowchart of FIG. #can be viewed as depicting an example of elements of a method implemented within the network environment 1000.

Beginning with block 1303, the client application 1049 can obtain and display one or more transaction records 1026. For example, the client application 1049 could send a query to the data store 1016 for a list of transaction records 1026 associated with the user account of the user and/or a specific transaction account 1019 associated with the user. The client application 1049 could then show or present these transaction records 1026 within a user interface 1053 on a display 1046 of the client device 1046. An example of a list of transactions shown within a user interface 1053 on the display 1046 of the client device 1046 is previously depicted in FIG. 4.

In some implementations, individual transaction records 1026 can indicate that a transaction has been previously modified. In these implementations, a previously modified transaction could be presented with an indicator. Examples of different approaches for indicating that a transaction has been previously modified are depicted in FIGS. 8 and 9.

Then, at block 1306, the client application 1049 can create a transaction modification request. For example, the client application 1049 could obtain a user selection of a transaction from the list of transactions shown within the user interface 1053. The user could then provide information regarding the amount to modify the transaction by (e.g., the amount of a tip to add to the transaction) and confirm his or choice. An example of this process is previously illustrated in FIGS. 5-7.

Once the user has specified the transaction to be modified and the amount to modify the transaction by, the client application 1049 could create a modification request which also specifies the merchant identifier 1031 of the merchant to be paid and the transaction account identifier 1036 of the transaction account to be used to fund the transaction modification. This additional information can be obtained in a number of ways. In some implementations, the client application 1049 could receive the merchant identifier 1031 and the transaction account identifier 1036 associated with each transaction record 1026 as part of the request for transaction records that was made at block 1303. In other implementations, the client application 1049 could request and receive the merchant identifier 1031 and the transaction account identifier 1036 associated with a specific transaction record 1026 (e.g., in response to a user selection of the specific transaction record 1026).

Next, at block 1309, the client application 1049 can send the transaction modification request created at block 1306 to the transaction authorization service 1013.

Subsequently, at block 1313, the transaction authorization service 1013 can generate a new transaction authorization request to reflect the transaction modification received from the client application 1049. For example, the transaction authorization service 1013 could generate a second authorization request that represents the additional amount specified by the client application 1049. The second authorization request could include the merchant identifier 1031 of the merchant to be paid and the transaction account identifier 1036 of the transaction account to be used to fund the transaction modification.

Proceeding to block 1316, the transaction authorization service 1013 can authorize the transaction authorization request generated at block 1306 and sent at block 1309. The transaction authorization service 1013 could also concurrently send a confirmation to the client application 1049 that the transaction represented by the transaction authorization request has been authorized.

Subsequently, at block 1319, the transaction authorization service 1013 can save a transaction record 1026 representing the transaction authorization request authorized at block 1316. The transaction record 1026 could also be flagged, when stored, to indicate that it represents a modified version of an original transaction. This could be done to allow the client application 1049 to indicate to a user which transactions have already been modified (e.g., which transactions have already had a tip added) compared to which transactions are unmodified.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 1003.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
determine that a transaction has been authorized for an account, the transaction including an authorization amount and a merchant identifier;
determine that the merchant identifier is included in a set of merchant identifiers associated with a transaction modification program;
determine that the account is included in a set of accounts enrolled with the transaction modification program; and
in response to the first determination that the merchant identifier is included in the set of merchant identifiers associated with the transaction modification program and the second determination that the account is included in a set of accounts enrolled with the transaction modification program, cause a notification to be sent to an application executing on a client device associated with the account, the notification indicating that the transaction is a modifiable transaction.

2. The system of claim 1, wherein the transaction is a previous transaction machine-readable instructions further cause the computing device to at least:
receive a transaction modification from the application executing on the client device, the transaction modification comprising a second authorization amount; and
cause a new transaction to be authorized, the new transaction comprising the authorization amount and the second authorization amount;
save a transaction record to a transaction data store, the transaction record representing the new transaction and including the authorization amount, the second authorization amount, and an indication that the new transaction is a modification of the previous transaction; and
reverse the previous transaction.

3. The system of claim 1, wherein the machine-readable instructions further cause the computing device to at least:
receive a transaction modification from the application executing on the client device, the transaction modification comprising a second authorization amount; and
cause a new transaction to be authorized, the new transaction comprising the second authorization amount; and
save a transaction record to a transaction data store, the transaction record representing the new transaction and including the second authorization amount, and an indication that the new transaction is a modification of the transaction.

4. The system of claim 3, wherein the machine-readable instructions further cause the computing device to at least:
receive a request for the new transaction record from the application executing on the client device;
retrieve a total transaction amount from the transaction record representing the new transaction; and
send the total transaction amount to the application executing on the client device and the indication that the new transaction is a modification of the transaction.

5. The system of claim 3, wherein the machine-readable instructions further cause the computing device to at least:
receive a request for the new transaction record from the application executing on the client device;
retrieve the authorization amount and the second authorization amount from the transaction record; and
send the authorization amount and the second authorization amount to the application executing on the client device.

6. The system of claim 3, wherein the machine-readable instructions further cause the computing device to at least send a confirmation that the new transaction has been authorized to the application executing on the client device.

7. The system of claim 1, wherein the machine-readable instructions further cause the computing device to at least:
determine that a transaction modification has not been received within a predefined period of time after the notification was sent to the application; and
send a second notification to the application executing on the client device, the second notification comprising a reminder that the transaction is a modifiable transaction.

8. A method, comprising:
determining that a transaction has been authorized for an account, the transaction including an authorization amount and a merchant identifier;
determining that the merchant identifier is included in a set of merchant identifiers associated with a transaction modification program;
determining that the account is included in a set of accounts enrolled with the transaction modification program; and
in response to the first determination that the merchant identifier is included in the set of merchant identifiers associated with the transaction modification program and the second determination that the account is included in a set of accounts enrolled with the transaction modification program, sending a notification to an application executing on a client device associated with the account, the notification indicating that the transaction is a modifiable transaction.

9. The method of claim 8, wherein the transaction is a previous transaction and the method further comprises:
receiving a transaction modification from the application executing on the client device, the transaction modification comprising a second authorization amount; and
causing a new transaction to be authorized, the new transaction comprising the authorization amount and the second authorization amount;
saving a transaction record to a transaction data store, the transaction record representing the new transaction and including the authorization amount, the second authorization amount, and an indication that the new transaction is a modification of the previous transaction; and
reversing the previous transaction.

10. The method of claim 8, wherein the method further comprises:
receive a transaction modification from the application executing on the client device, the transaction modification comprising a second authorization amount; and
cause a new transaction to be authorized, the new transaction comprising the second authorization amount; and
save a transaction record to a transaction data store, the transaction record representing the new transaction and including the second authorization amount, and an indication that the new transaction is a modification of the transaction.

11. The method of claim 10, wherein the method further comprises:
receiving a request for the new transaction record from the application executing on the client device;
retrieving a total transaction amount from the transaction record representing the new transaction; and
sending the total transaction amount to the application executing on the client device and the indication that the new transaction is a modification of the transaction.

12. The method of claim 10, wherein the method further comprises:
receiving a request for the new transaction record from the application executing on the client device;
retrieving the authorization amount and the second authorization amount from the transaction record; and
sending the authorization amount and the second authorization amount to the application executing on the client device.

13. The method of claim 10, wherein the method further comprises:
sending a confirmation that the new transaction has been authorized to the application executing on the client device.

14. The method of claim 8, wherein the method further comprises:
determining that a transaction modification has not been received within a predefined period of time after the notification was sent to the application; and
sending a second notification to the application executing on the client device, the second notification comprising a reminder that the transaction is a modifiable transaction.

15. A system, comprising:
a computing device comprising a processor and a memory; and
machine-readable instructions stored in the memory that, when executed by the processor, cause the computing device to at least:
receive, from a point-of-sale (POS) application, an original transaction authorization request for a transaction and a transaction modification request for the transaction, the original transaction authorization request specifying an original amount for the transaction;
identify a client device associated with a transaction account identified by the original transaction authorization request;
send a notification to a client application executing on a client device associated with the transaction account, the notification indicating that the transaction is a modifiable transaction;
receive a transaction modification from the client application, the transaction modification specifying an additional amount for the transaction;
generate a new transaction authorization request that comprises the original amount for the transaction and the additional amount for the transaction; and
authorize the new transaction authorization request.

16. The system of claim 15, wherein the machine-readable instructions, when executed by the processor, further cause the computing device to at least discard the original transaction authorization request.

17. The system of claim 15, wherein the machine-readable instructions, when executed by the processor, further cause the computing device to at least save a transaction record that represents a new transaction associated with the new transaction request.

18. The system of claim 17, wherein the transaction record indicates that the new transaction is a modification of the transaction.

19. The system of claim 15, wherein the machine-readable instructions further cause the computing device to at least send a confirmation that the new transaction authorization request has been authorized to the client application executing on the client device.

20. The system of claim 15, wherein the machine-readable instructions further cause the computing device to at least:
determine that a transaction modification has not been received within a predefined period of time after the notification was sent to the application; and
send a second notification to the application executing on the client device, the second notification comprising a reminder that the transaction is a modifiable transaction.
